(19) United States
(12) Patent Application Publication
(10) Pub. No.: US 2012/0282120 A1
(43) Pub. Date: Nov. 8, 2012

(54) ELECTRIC CABLE, ELECTRIC MOTOR AND ELECTRIC SUBMERSIBLE PUMP

(75) Inventors: John Raymond Krahn, Schenectady, NY (US); Weijun Yin, Niskayuna, NY (US); Manoj Ramprasad Shah, Latham, NY (US)

(73) Assignee: GENERAL ELECTRIC COMPANY, SCHENECTADY, NY (US)

(21) Appl. No.: 13/098,911

(22) Filed: May 2, 2011

(51) Int. Cl. F04D 13/08; H02K 5/132; H01B 9/06; H02K 9/19

(52) U.S. Cl. 417/410.1; 310/54; 310/87; 174/24

(57) ABSTRACT

In accordance with one aspect of the present invention, an electric motor is provided that includes a housing, a stator, and a rotor, wherein the stator and rotor are disposed within the housing. The housing, the stator, and the rotor define an internal volume within the housing, said internal volume configured to receive a dielectric fluid. The electric motor further includes at least one electric cable configured to electrically power the electric motor, wherein the electric cable includes at least one electrical conductor disposed within at least one protective layer, and wherein the electrical conductor and the protective layer define at least one channel configured to deliver the dielectric fluid to the internal volume. An electric submersible pump system is also provided.

### STATEMENT REGARDING FEDERALLY SPONSORED RESEARCH & DEVELOPMENT

This invention was made with Government support under contract number DE-EE0002752 awarded by the DOE. The Government may have certain rights in the invention.

### BACKGROUND

1. Technical Field

The invention relates to electric cables for electric motors. Further, the invention relates to an electric motor configured to operate an electric submersible pump in high temperature environments.

2. Discussion of Related Art

Electrical submersible pump (ESP) systems are used in a wide variety of environments, including wellbore applications and well fluid lifting in an enhanced geothermal system for pumping production fluids, such as, water or petroleum. The submersible pump system includes, among other components, an induction motor used to power a pump, lifting the production fluids to the surface. Further, a power cable including a conductor and an insulating layer typically extends downhole to power the electric motor.

In certain applications, for example, down-hole ESP systems for drilling in oil and gas industries, it may be desirable to operate the ESP motor at high temperatures (for example, greater than 300° C.). However, high temperatures may lead to undesirable degradation of the electrical insulation used in the electric cables for ESP motors. Typically, the insulating layers used in electric cables for ESP motors include organic insulation material, such as, polymer-based insulations that are configured to operate at low temperatures. The dielectric properties of these polymeric insulations tend to degrade over time at high temperatures.

Further, it may be desirable to maintain a pressure differential (for example, positive) between the ESP motor and the wellbore to prevent ingress of the pumped fluid (for example, salt water) across the seals into the motor. This may be achieved, in some cases, by using motor protection systems including a combination of bellows and springs. The bellows are typically connected to an oil reserve that compensates for the motor oil expansion and contraction and thus helps in maintaining a positive pressure differential between the motor and the well bore. However, the oil reserve typically has a limited capacity and further during the operational lifetime of the ESP system the oil contained within the oil reserve may leak through the seals. This may lead to low pressure environment within the motor and ingress of water or other contaminants within the motor, which could lead to failure of the motor components and the motor.

Thus, there is a need for providing electric motor configurations that allow for pressurized oil to be delivered within the motor to maintain the desired pressure differential. Further, there is a need for improved insulated electric cables that allow continuous operation of the ESP motor in high temperature environments for an extended period of time.

### BRIEF DESCRIPTION

In accordance with one aspect of the present invention, an electric motor is provided. The electric motor includes a housing, a stator, and a rotor; wherein the stator and rotor are disposed within the housing. The housing, the stator, and the rotor define an internal volume within the housing, said internal volume configured to receive a dielectric fluid. The electric motor assembly further includes at least one electric cable configured to electrically power the electric motor, wherein the electric cable includes at least one electrical conductor disposed within at least one protective layer, and wherein the electrical conductor and the protective layer define at least one channel configured to deliver the dielectric fluid to the internal volume.

In accordance with another aspect of the present invention an electric submersible pump system is provided. The electric submersible pump system includes a pump and an electric motor. The electric motor includes a housing, a stator; and a rotor, wherein the stator and rotor are disposed within the housing, and wherein the housing, the stator, and the rotor define an internal volume within the housing, said internal volume configured to receive a dielectric fluid. The electric submersible pump system further includes at least one electric cable configured to electrically power the electric motor, wherein the electric cable includes at least one electrical conductor disposed within at least one protective layer. The electrical conductor and the protective layer define at least one channel configured to deliver the dielectric fluid to the internal volume.

In accordance with yet another aspect of the present invention, an electric cable is provided. The electric cable includes at least one electrical conductor disposed within at least one protective layer, wherein the electrical conductor and the protective layer define at least one channel configured to receive a dielectric fluid, and wherein the electric cable is configured to deliver the dielectric fluid to an internal volume within the electric motor.

Other embodiments, aspects, features, and advantages of the invention will become apparent to those of ordinary skill in the art from the following detailed description, the accompanying drawings, and the appended claims.

### BRIEF DESCRIPTION OF THE DRAWING FIGURES

These and other features, aspects, and advantages of the present invention will become better understood when the following detailed description is read with reference to the accompanying drawings in which like characters represent like parts throughout the drawings, wherein:

FIG. 1 is a side view of an electrical submersible pump disposed within a wellbore in accordance with one embodiment of the invention.

FIG. 2A is a side view of an electric motor in accordance with one embodiment of the invention.

FIG. 2B is a side view of an electric motor in accordance with one embodiment of the invention.

FIG. 3A is a side view of an electric motor in accordance with one embodiment of the invention.

FIG. 3B is a side view of an electric motor in accordance with one embodiment of the invention.

FIG. 4 is a schematic of an electric cable in accordance with one embodiment of the invention.

FIG. 5 is a cross-sectional view of an electric cable in accordance with one embodiment of the invention.

FIG. 6 is a cross-sectional view of an electric cable in accordance with one embodiment of the invention.

FIG. 7 is a cross-sectional view of an electric cable in accordance with one embodiment of the invention.

FIG. 8 is a schematic of an electric cable in accordance with one embodiment of the invention.

FIG. 9 is a schematic of an electric cable in accordance with one embodiment of the invention.

### DETAILED DESCRIPTION

As discussed in detail below, embodiments of the present invention include electric cable configurations for electric motors and electric submersible pump (ESP) systems. In some embodiments, the electric motor and ESP systems may be deployed in a wellbore to pump fluids disposed in a subterranean environment.

The electric cable is advantageously configured to power the electric cable and also deliver a dielectric fluid to an interior volume of the electric motor. In certain embodiments, a combination of an electrical conductor and a dielectric fluid advantageously allows the electric cable, the electric motor, and the ESP system to operate in high temperature environments or applications where the system is exposed to high temperature conditions. The electric cable further provides a channel or conduit for delivering a dielectric fluid to an interior volume of the motor housing. The delivered dielectric fluid advantageously helps in maintaining a desired pressure differential between the motor and an external environment (for example, well bore environment). In certain embodiments, the delivered dielectric fluid provides a positive pressure differential between the motor and the well bore, thus precluding ingress of external fluids (for example, salt water) into the motor.

According to some embodiments of the invention, the electric motor assembly and electric cable configurations advantageously provide an external oil reserve to maintain the desired pressure within the motor housing, which is not limited by the capacity of the oil reserve connected to the bellows. Further, the electric cable configurations, according to some embodiments of the invention, advantageously reduce the number of cables (for example, separate oil delivery cable and power cable) extending to the motor and thus reduce the volume loss within the well-bore due to these cables. Furthermore, the electric cable configurations, according to some embodiments of the invention, advantageously allow for oil pressure within the motor to be monitored and controlled using remote sensing.

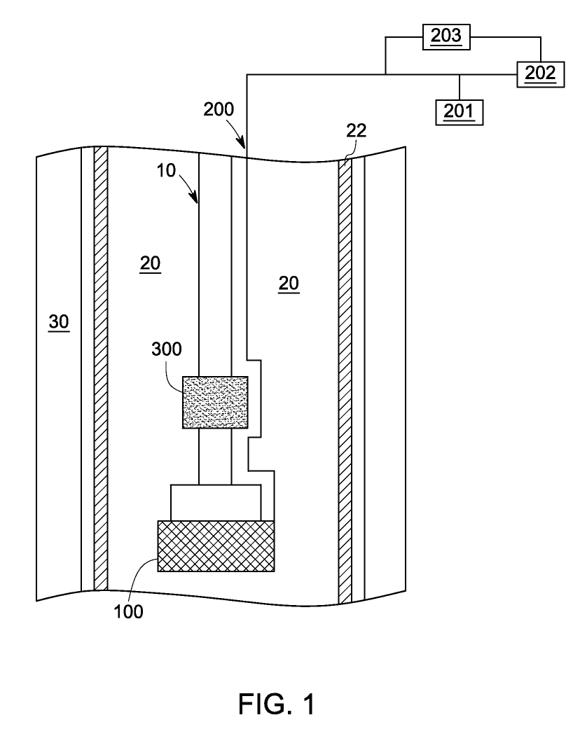

Referring to FIG. 1, an exemplary ESP system 10 is illustrated wherein the ESP system is disposed within a wellbore 20. In one embodiment, the wellbore 20 is formed in a geological formation 30, for example, an oilfield. The wellbore 20 is further lined by a casing 22, as indicated in FIG. 1. In some embodiments, the casing 22 may be further perforated to allow a fluid to be pumped (referred to herein as “production fluid”) to flow into the casing 22 from the geological formation 30 and pumped to the surface of the wellbore 20.

As further illustrated in FIG. 1, the ESP system 10 includes a pump (for example, an electric submersible pump) 300, an electric motor 100 configured to operate the pump 300, and an electric cable 200 configured to power the electric motor 100. As noted earlier, the ESP system 10 according to some embodiments of the invention is disposed within a wellbore 20 for continuous operation over an extended period of time. Accordingly, in such embodiments, the ESP system 10 and the components of the ESP system 10 may be subjected to extreme conditions such as high temperatures, high pressures, and exposure to contaminants. The extreme conditions may lead to degradation of insulating coatings of the electric cable or ingress of pumped fluid and/or contaminations into the motor.

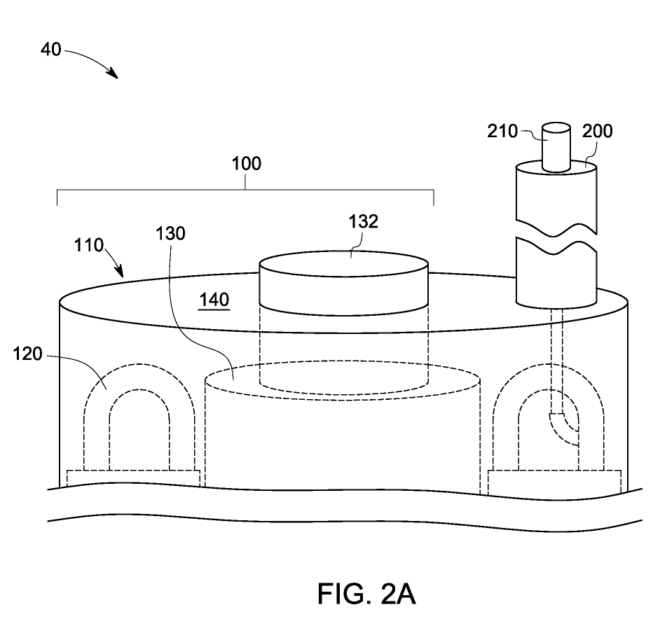

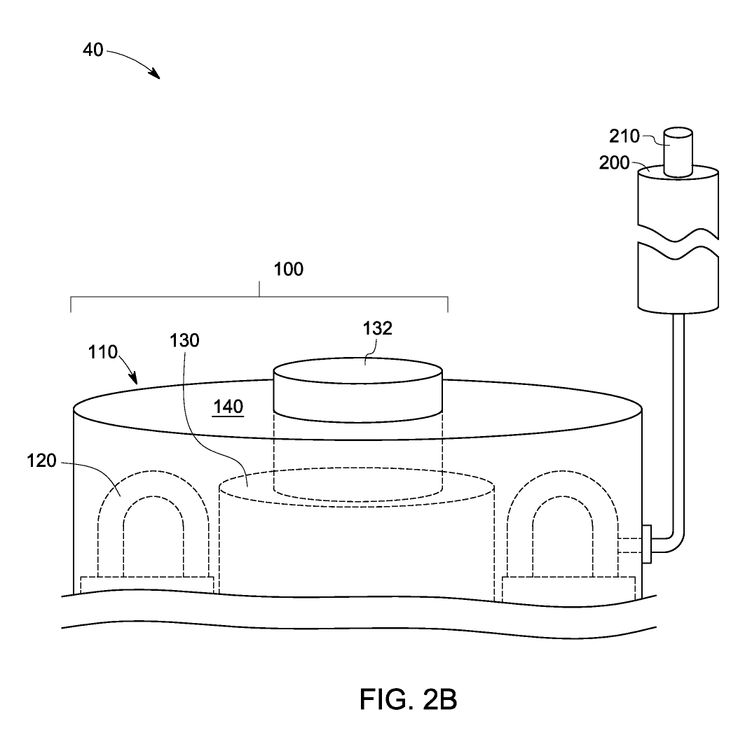

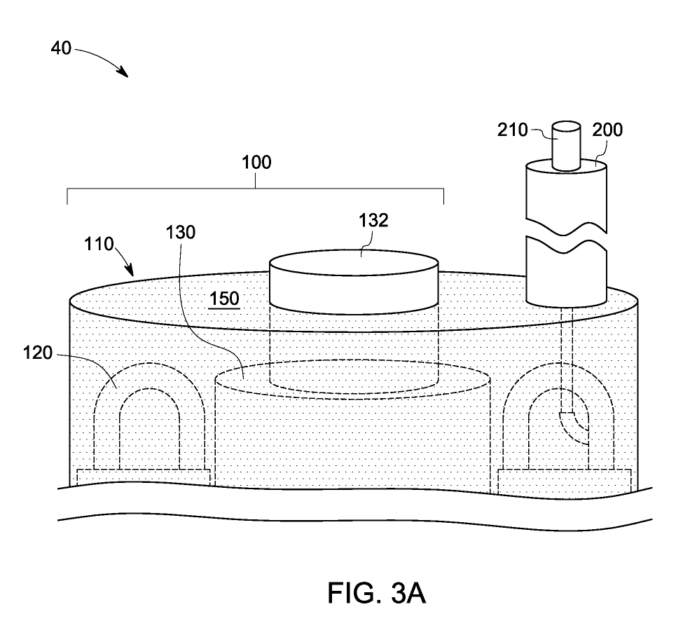

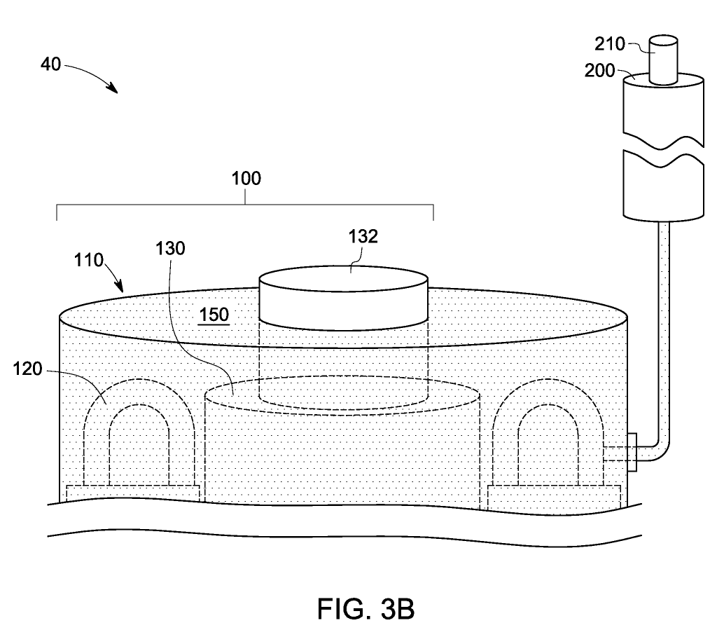

In one embodiment, the present invention provides an electric motor assembly 40 capable of withstanding high temperatures, high pressures, and exposure to contaminants. With reference to FIGS. 2A and 2B, the electric motor assembly 40 includes an electric motor 100 and an electric cable 200 configured to power the electric motor 100. The electric motor 100, according to an embodiment of the invention, includes a housing 110, a stator 120, and a rotor 130, wherein the stator 120 and the rotor 130 are disposed within the housing 110. In one embodiment, the housing 110, the stator 120, and the rotor 130 define an internal volume 140 within the housing 110, said internal volume 140 configured to receive a dielectric fluid 150, as indicated in FIGS. 2A and 3A. The terms “electric motor” and “motor” are used herein interchangeably. Similarly, the terms “electric cable” and “cable” are used herein interchangeably.

Referring to FIGS. 2A and 3A, in one embodiment, the motor 100 includes an elongated cylindrical housing 110. In one embodiment, the housing 110 is a pressurized vessel. In some embodiments, the motor 100 further includes at least one motor protection system (not shown). In one embodiment, the motor protection system includes one or more bellows, springs, and an oil reservoir. As noted earlier, the electric cable 200, according to some embodiments of the invention, allows for delivery of dielectric oil to the motor housing 110 in a controlled manner, thus maintaining the desired pressure within the motor housing 110.

In one embodiment, the motor 100 further includes a stator 120 disposed within the housing 110. In one embodiment, the stator 120 includes a plurality of metallic laminations disposed within the housing. In one embodiment, to form electrical phases within the stator a plurality of windings are wrapped around the laminations (not shown). The motor 100 further includes a rotatable component or a rotor 130. In one embodiment, the rotor 130 includes a drive shaft 132 that extends longitudinally out from the housing 110 and further interconnects to the pump 300, described earlier with reference to FIG. 1.

The electric motor assembly 40 further includes at least one electric cable 200 configured to electrically power the electric motor 100, as indicated in FIGS. 2A and 3A. FIGS. 2B and 3B illustrate alternate embodiments of the invention, wherein the electric cable 200 is configured to connect to the motor housing 110 from the outside as compared to the configurations illustrated in FIGS. 2A and 3A. Any other suitable configurations are also within the scope of the invention.

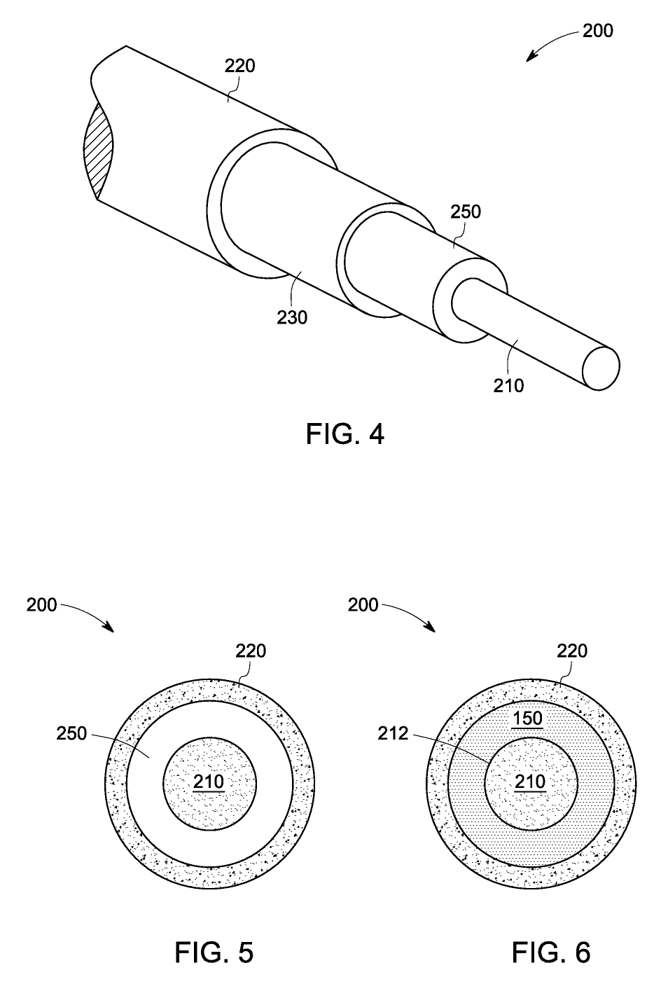

Referring now to FIG. 4, the electric cable 200 includes at least one electrical conductor 210 disposed within at least one protective layer 220. The electrical conductor 210 and the protective layer 220 define at least one channel 250 configured to deliver the dielectric fluid 150 to the internal volume 140 of the motor, as indicated in FIG. 4. In some embodiments, the channel 250 provides a fluid transfer path between an external delivery pump and the motor 100. In certain embodiments, the channel 250 provides an oil transfer path. In some embodiments, the channel 250 further includes a porous material or solid structures (for example, stays) that allow for the dielectric fluid 150 to flow along the length of the electric cable 200.

Referring now to FIG. 5, a cross-sectional view of an electric cable 200, in accordance with an exemplary embodiment of the invention is shown. The electric cable 200 includes an electrical conductor 210 disposed within a protective layer 220. In one embodiment, the electrical conductor 210 includes copper. In one embodiment, the electrical conductor 210 includes a copper alloy. In one embodiment, the electrical conductor 210 includes a single drawn wire of copper or copper alloys. In another embodiment, the electrical conductor 210 includes a plurality of copper or copper alloy wires twisted together.

In one embodiment, the protective layer 220 includes a single layer or a plurality of protective layers. In one embodiment, the protective layer 220 is disposed around the electrical conductor 210 in the form of a coating, a fabric, a tape, a fiber, a braid, a tube, or a combination thereof. In some embodiments, an additional adhesive layer (not shown) may be interposed between the electrical conductor 210 and the protective layer 220 such that a channel 250 is defined. As noted earlier, the channel 250 is configured to deliver a dielectric fluid 150 within the internal volume 140.

In one embodiment, the protective layer 220 includes a material suitable for protecting the electrical conductor 210 in the environment in which it is deployed. For example, protective layer 220 in the illustrated embodiments includes a material that may provide physical protection to conductor 210 in a high temperature wellbore environment 20. In some embodiments, the protective layer 220 includes a metallic material, such as, stainless steel, nickel, inconel, carbon steel, lead, or combinations thereof.

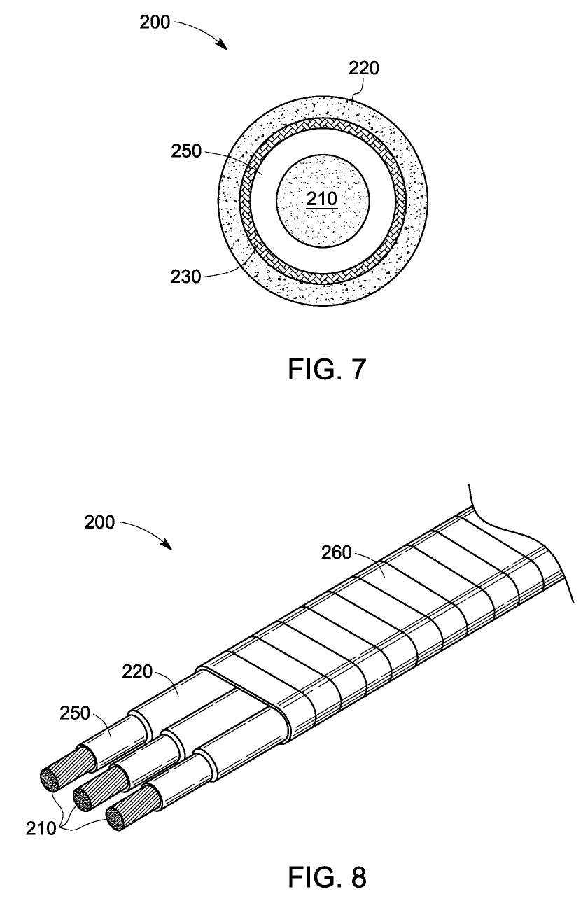

In one embodiment, the electric cable 200 further includes an optional metal layer 230 interposed between the electrical conductor 210 and the protective layer 220, as indicated in FIGS. 4 and 7. In some embodiments, the metal layer 230 in combination with the protective layer 220 defines a channel or oil transfer path 250 for the dielectric fluid 150, as indicated in FIGS. 4 and 7.

In one embodiment, the electric cable is a coaxial cable. The term coaxial as used herein means that the electrical conductor 210 and the protective layer 220 have a common axis. In another embodiment, the electrical conductor 210, the metal layer 230, and the protective layer 220 have a common axis.

In one embodiment, the electric cable 200 has a length in a range from about 1 meter to about 20000 meters. In another embodiment, the electric cable 200 has a length in a range from about 10 meters to about 10000 meters. In yet another embodiment, the electric cable 200 has a length in a range greater than about 20000 meters.

In one embodiment, the electric motor assembly 40 includes an electric cable 200 including a plurality of electrical conductors 210. In one embodiment, at least one of the plurality of electrical conductors 210 is disposed within a protective layer 220, as described earlier. In such embodiments, the at least one electrical conductor 210 and the protective layer 220 define a channel 250 configured to deliver the dielectric fluid 150 to the internal volume 140 of the motor 100.

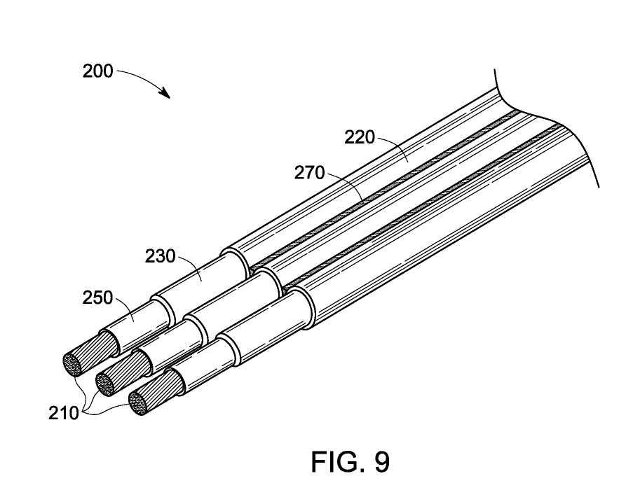

In another embodiment, the electric motor assembly 40 includes an electric cable 200 including a plurality of electrical conductors 210 and a plurality of protective layers 220, as indicated in FIGS. 8 and 9. In some embodiments, each one of the plurality of electrical conductors 210 are disposed within a protective layer 220, wherein the electrical conductor 210 and the protective layer 220 define a channel 250 configured to deliver the dielectric fluid 150 to the internal volume 140 of the motor 100. The number of electrical conductors may depend on the motor configuration and power requirements.

In some embodiments, wherein a plurality of electrical conductors 210 may be used to power the electric motor 100, the plurality of electrical conductors may be further tied or bundled together, using for example, a protective sheath, as shown in FIG. 8. FIG. 8 shows an electrical cable 200, according to an embodiment of the invention, the electrical cable 200 includes a plurality (for example, three) electrical conductors 210. Each one of the electrical conductors 210 is disposed within a protective layer 220, wherein the electrical conductor and the protective layer 220 define a channel 250 for delivery of dielectric fluid 150. The plurality of electrical conductors 210 and protective layers 220 are further bundled together in a protective sheath 260, as indicated in FIG. 8.

In some embodiments, wherein a plurality of electrical conductors 210 may be used to power the electric motor 100, the plurality of electrical conductors may be further tied or bundled together, using for example, adhesive, as shown in FIG. 9. FIG. 9 shows an electrical cable 200 according to an embodiment of the invention, the electrical cable 200 includes a plurality (for example, three) electrical conductors 210. Each one of the electrical conductor 210 is disposed within a protective layer 220, wherein the electrical conductor 210 and the protective layer 220 define a channel 250 for delivery of dielectric fluid. The plurality of electrical conductors 210 and protective layers 220 are further tied together using adhesive 270, as indicated in FIG. 9. In some embodiment, an optional metal layer 230 may be further interposed between the electrical conductor 210 and the protective layer 220.

Referring to FIG. 6, in one embodiment, the channel 250 within the electric cable 200 further includes a dielectric fluid 150. Accordingly, in some embodiments, the channel 250 advantageously allows for the electrical conductor 210 to be in fluid communication with a dielectric fluid 150. In one embodiment, the dielectric fluid 150 is in contact with a surface 212 of the electrical conductor and configured to provide thermal and electrical insulation to the electrical conductor 210. This is in contrast to a polymeric insulating layer disposed on an electrical conductor, where the electrical conductor is insulated via the polymeric insulating layer.

Without being bound by any theory, it is believed that the dielectric fluid 150 may provide the desired thermal and electrical insulation to the electrical conductor 210 and thus obviate the need for a separate high temperature insulation, such as, for example, a polymer layer. In one embodiment, the electric cable 200, in accordance with certain embodiments of the invention, may be substantially free of a polymeric insulating layer. In one embodiment, the dielectric fluid 150 may provide high temperature insulation to the electrical conductor 210 and advantageously allows for continuous operation of the electric cable 200 and the electric motor 100 at temperatures greater than about 300° C. Continuous operation may refer to a period of operation longer than one hour and up to at least 5 years.

Referring to FIG. 3, in one embodiment, the internal volume 140 as defined by the housing 110, the stator 140, and the rotor 160 contains a dielectric fluid 150. As noted earlier, the dielectric fluid 150 is disposed within the internal volume 140 such that dielectric fluid is configured to provide a determined pressure differential between the internal volume of the motor and an environment external to the motor (for example, a well bore). The term “determined” pressure differential refers to a pressure differential required to prevent ingress of external fluids into the motor.

In one embodiment, the dielectric fluid 150 is disposed within the internal volume 140 such that dielectric fluid is configured to provide a pressure in the internal volume 140 of the motor 100 that is substantially the same as the pressure in an environment external to the motor 100. In another embodiment, the dielectric fluid 150 is disposed within the internal volume 140 such that the dielectric fluid 150 is configured to provide a negative pressure differential between the internal volume 140 of the motor and an environment external to the motor 100. In one particular embodiment, the dielectric fluid 150 is disposed within the internal volume 140 such that dielectric fluid is configured to provide a positive pressure differential between the internal volume 140 of the motor 100 and an environment external to the motor 100.

In some embodiments, the dielectric fluid 150 disposed within the interior volume 140 of the motor 100 is in fluid communication with the channel 250 of the electric cable 200. In certain embodiments, the dielectric fluid 150 disposed within the interior volume 140 of the motor 100 is in fluid communication with the dielectric fluid 150 disposed within the channel 250 of the electric cable 200.

In some embodiments, the dielectric fluid 150 has a boiling point greater than about 300° C. at the operating conditions (for example, operating pressure) and the dielectric fluid may allow for operation of the electric cable 200 and the electric motor 100 at temperatures greater than about 300° C. In some other embodiments, the dielectric fluid 150 may be subjected to a high pressure to increase the boiling temperature of the dielectric fluid 150 to a temperature greater than about 300° C.

In one embodiment, the dielectric fluid 150 is selected from the group consisting of high molecular weight transformer oils, synthetic and natural ester oils, polychlorinated biphenyls, pentaerythritol tetra fatty esters, dipheny-dimethyl siloxane fluids, phenylmethyl silicone fluids, heavy paraffinic petroleum distillates, perflorinated polyether fluids, and combinations thereof. In one embodiment, the dielectric fluid 150 is selected from the group consisting of a silicone oil, a mineral oil, a synthetic ester oil, a natural ester oil such as vegetable oil, a perflorinated polyether, and combinations thereof.

Referring again to FIG. 1, in one embodiment, the electric cable 200 is further connected to a distal power source 210, wherein the power source 201 is configured to provide electrical power to the motor 100. In one embodiment, the electric cable 200 is further connected to a delivery pump 202 configured to pump the dielectric fluid 150 into the channel 250 of the electric cable 200. In some embodiments, the delivery pump 202 is configured to pump the dielectric fluid 150 from the surface of the wellbore 20.

As noted earlier, according to some embodiments of the invention, the electric motor assembly 40 and the electric cable 200 configuration advantageously provide an external oil reserve to maintain the desired pressure within the motor housing, which is not limited by the capacity of the oil reserve connected to the bellows in the motor. Further, the electric cable 200 configuration, according to some embodiments of the invention, advantageously reduce the number of cables (for example, separate oil delivery cable and power cable) extending to the motor 100 and thus reduce the volume loss within the wellbore 20 due to these cables.

Referring now to FIG. 1, in one embodiment, a remote sensing system 203 may be connected to the electric motor 100, wherein the remote sensing system 203 is capable of determining the oil pressure within the electric motor 100. As shown in FIG. 1, in some embodiments, the remote sensing system 203 may be further connected to the electric cable 200, wherein the remote sensing system provides inputs to the delivery pump 202 in response to a pressure change within the motor. The electric cable 200 configuration, according to some embodiments of the invention, advantageously allows for oil pressure within the motor 100 to be monitored and controlled using a remote sensing system 203.

In one embodiment, the electric motor 100 is configured to operate a pump 300 in a borehole 20, as indicated in FIG. 1. In one embodiment, the electric motor 100 is configured to operate an electrical submersible pump 300, as indicated in FIG. 1. In one particular embodiment, the electric cable 200 is configured to allow operation of the electric motor 100 at a temperature greater than about 300° C. in a borehole 20.

In one embodiment, an ESP system is provided. Referring to FIG. 1, in one embodiment, the ESP system 10 is installed in a wellbore 20. In one embodiment, the ESP system 10 is installed in an oilfield 30. In some embodiments, the ESP system 10 may be capable of pumping production fluids from a wellbore 20 or an oilfield 30. The production fluids may include hydrocarbons (oil) and water, for example.

In some embodiments, the ESP system 10 is installed in an oilfield 30 by drilling a hole or a wellbore 20 in a geological formation 30, for example an oilfield. The wellbore 20 maybe vertical, and may be drilled in various directions, for example, upward or horizontal. In one embodiment, the wellbore 20 is cased with a metal tubular structure referred to as a casing 22. In some embodiments, cementing between the casing 22 and the wellbore 20 may also be provided. Once the casing 22 is provided inside the wellbore 20, the casing 22 may be perforated to connect the formation 30 outside of the casing 22 to the inside of the casing 22. In some embodiments, an artificial lift device such as the ESP system 10 of the present invention may be provided to drive downhole well fluids to the surface. The ESP system 10 according to some embodiments of the invention is used in oil production to provide an artificial lift to the oil to be pumped.

An ESP system 10 may include surface components, for example, an oil platform (not shown) and sub-surface components (found in the borehole). In one embodiment, the ESP system 10 further includes surface components such as motor controller surface cables and transformers (not shown). In one embodiment, the subsurface components include pump, motor, seal, and cables.

Referring again to FIG. 1, in one embodiment, an ESP system 10 includes sub-surface components such as a pump 300 and an electric motor 100 configured to operate the pump 300. In one embodiment, the electric motor 100 is a submersible two-pole, squirrel cage, induction electric motor. In one embodiment, the electric motor 100 is a permanent magnet motor. The motor size may be designed to lift the desired volume of production fluids. In one embodiment, the pump 300 is a multi-stage unit with the number of stages being determined by the operating requirements. In one embodiment, each stage of the pump 300 includes a driven impeller and a diffuser which directs flow to the next stage of the pump. In some embodiments, the ESP system may further include additional components such as seals, bellows, or springs (not shown).

In one embodiment, as indicated in FIG. 1, the electric motor 100 is further coupled to an electrical power cable 200. In one embodiment, the electric cable 200 is coupled to the electric motor 100 by an electrical connector (not shown). In one embodiment, the electric cable 200 includes a motor lead and a connector is mounted on the motor lead of the electrical cable 200 (not shown). The connector electrically connects and secures the motor lead of the electric cable 200 to the housing 110 of the motor 100.

In some embodiments, the electrical power cable 200 provides the three phase power needed to power the electric motor 100 and may have different configurations and sizes depending on the application. In some embodiments, the electrical power cable 200 is designed to withstand the high-temperature wellbore environment.

Further, as noted earlier, in one embodiment, the electric motor includes a housing 110, a stator 120, and a rotor 130 wherein the stator and rotor are disposed within the housing, as indicated in FIGS. 2A and 3A. As noted earlier, the housing 110, the stator 120, and the rotor 130 define an internal volume 140 within the housing 110, said internal volume 120 configured to receive a dielectric fluid 150, as indicated in FIG. 3.

Furthermore, the electric cable 200 includes at least one electrical conductor 210 disposed within at least one protective layer 220. The electrical conductor 210 and the protective layer 220 define a channel 250 configured to deliver the dielectric fluid 150 to the internal volume 140 of the motor, as indicated in FIG. 4.

In certain embodiments, the electric cable 150 advantageously allows the electric motor 100 and the ESP system 10 to operate in high temperature environments or applications where the system is exposed to high temperature conditions. The channel 250 advantageously allows for the electrical conductor 210 to be in fluid communication with a dielectric fluid 150. The dielectric fluid 150 provides thermal and electrical insulation to the electrical conductor 210, thus allowing the electric cable 200, the electric motor 100, and the ESP system 10 to continuously operate at temperatures greater than about 300° C.

Further, in certain embodiments, the electric cable 150 advantageously allows a dielectric fluid 150 to be delivered to the interior volume 140 of the motor housing 110. In some embodiments, the delivered dielectric fluid 150 is advantageously configured to provide a positive pressure differential between the internal volume 140 of the motor 100 and an environment external to the motor 100, thus precluding ingress of external fluids inside the motor 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electric motor assembly, comprising:
(a) an electric motor comprising:
(i) a housing;
(ii) a stator; and
(ii) a rotor;
wherein the stator and rotor are disposed within the housing, and wherein the housing, the stator, and the rotor define an internal volume within the housing, said internal volume configured to receive a dielectric fluid; and
(b) at least one electric cable configured to electrically power the electric motor, wherein the electric cable comprises at least one electrical conductor disposed within at least one protective layer,
and wherein the electrical conductor and the protective layer define at least one channel configured to deliver the dielectric fluid to the internal volume.

2. The electric motor assembly as defined in claim 1, further comprising the dielectric fluid disposed within the channel.

3. The electric motor assembly as defined in claim 2, wherein the dielectric fluid is in contact with a surface of the electrical conductor and configured to provide electrical insulation to the electrical conductor.

4. The electric motor assembly as defined in claim 1, further comprising the dielectric fluid disposed in the internal volume, wherein the dielectric fluid is in fluid communication with the channel.

5. The electric motor assembly as defined in claim 1, further comprising the dielectric fluid disposed in the internal volume,
wherein the dielectric fluid is configured to provide a determined pressure differential between the internal volume of the motor and an environment external to the motor.

6. The electric motor assembly as defined in claim 1, wherein the dielectric fluid is selected from the group consisting of a silicone oil, a mineral oil, a synthetic ester oil, a natural ester oil, a perflorinated polyether, and combinations thereof.

7. The electric motor assembly as defined in claim 1, further comprising a metal layer interposed between the electrical conductor and the protective layer.

8. The electric motor assembly as defined in claim 1, wherein the electrical conductor comprises copper.

9. The electric motor assembly as defined in claim 1, wherein the at least one electric cable is a coaxial cable.

10. The electric motor assembly as defined in claim 1, wherein the at least one electric cable has a length in a range from about 1 meter to about 20,000 meters.

11. The electric motor assembly as defined in claim 1, wherein the electric cable is connected to the electric motor and a distal electric power source.

12. The electric motor assembly as defined in claim 1, wherein the electric cable is connected to a delivery pump configured to pump the dielectric fluid into the channel of the electric cable.

13. The electric motor assembly as defined in claim 1, wherein the electric cable comprises a plurality of electrical conductors disposed within a plurality of protective layers,
and wherein the plurality of electrical conductors and the plurality of protective layers define a plurality of channels configured to deliver the dielectric fluid to the internal volume.

14. The electric motor assembly as defined in claim 1, wherein the electric motor is configured to operate an electrical submersible pump.

15. An electric submersible pump system, comprising:
(a) a pump;
(b) an electric motor comprising:
(i) a housing;
(ii) a stator; and
(ii) a rotor;
wherein the stator and rotor are disposed within the housing, and wherein the housing, the stator, and the rotor define an internal volume within the housing, said internal volume configured to receive a dielectric fluid; and
(c) at least one electric cable configured to electrically power the electric motor, wherein the electric cable comprises at least one electrical conductor disposed within at least one protective layer,
and wherein the electrical conductor and the protective layer define at least one channel configured to deliver the dielectric fluid to the internal volume.

16. The electric submersible pump system as defined in claim 15, further comprising the dielectric fluid disposed within the channel,
wherein the dielectric fluid is in contact with a surface of the electrical conductor and configured to provide electrical insulation to the electrical conductor.

17. The electric submersible pump system as defined in claim 16, further comprising the dielectric fluid disposed in the internal volume,
wherein the dielectric fluid is configured to provide a determined pressure differential between the internal volume of the motor and an environment external to the motor.

18. The electric submersible pump system as defined in claim 15, wherein the electric cable is connected to a delivery pump configured to pump the dielectric fluid into the channel of the electric cable.

19. The electric submersible pump system as defined in claim 15, wherein the dielectric fluid is selected from the group consisting of a silicone oil, a mineral oil, a synthetic ester oil, a natural ester oil, a perflorinated polyether, and combinations thereof.

20. An electric cable configured to electrically power an electric motor in an electric submersible pump, said electric cable comprising:
at least one electrical conductor disposed within at least one protective layer,
wherein the electrical conductor and the protective layer define at least one channel configured to receive a dielectric fluid, and
wherein the electric cable is configured to deliver the dielectric fluid to an internal volume within the electric motor.
